(19) United States
(12) Patent Application Publication
(10) Pub. No.: US 2019/0006678 A1
(43) Pub. Date: Jan. 3, 2019

(54) SECONDARY BATTERY, HALF CELL AND PRODUCTION METHOD OF SECONDARY BATTERY

(71) Applicant: Hitachi, Ltd., Tokyo (JP)

(72) Inventors: Kazuaki NAOE, Tokyo (JP); Yusuke KAGA, Tokyo (JP); Shimpei AMASAKI, Tokyo (JP); Makoto ABE, Tokyo (JP); Etsuko NISHIMURA, Tokyo (JP); Akihiko NOIE, Tokyo (JP)

(21) Appl. No.: 15/935,165

(22) Filed: Mar. 26, 2018

(30) Foreign Application Priority Data
Jun. 29, 2017 (JP) 2017-127643

(51) Int. Cl. H01M 4/62; H01M 10/0525; H01M 4/1399

(52) U.S. Cl. CPC H01M 4/623; H01M 2300/0034; H01M 4/1399; H01M 10/0525

(57) ABSTRACT

Proposed are a secondary battery, a half cell and a production method of a secondary battery capable of exhibiting the designed battery capacity. In a secondary battery comprising an electrode containing an electrode active material and a binding agent, and an electrolyte, the electrolyte contains an electrolytic solution, the electrode further contains the electrolytic solution, and a binding agent amount on a surface of the electrode active material is smaller than an average of the binding agent amount of the electrode.

### TECHNICAL FIELD

The present invention relates to a secondary battery, a half cell and a production method of a secondary battery, and more particularly relates to a lithium ion secondary battery.

### BACKGROUND ART

A secondary battery is being used as the power source of various devices and systems such as portable electronic devices, electric vehicles and hybrid vehicles. Among the above, a lithium ion battery is advantageous in that its energy density is high in comparison to other secondary batteries such as a sodium sulfur battery. Because a conventional lithium ion battery comprises an electrolyte formed from an organic electrolytic solution, when damaged, there was a risk of leakage or spurting of the organic electrolytic solution. Thus, the development of an electrolyte as an alternative to an organic electrolytic solution is being advanced. For instance, PTL 1 proposes an all-solid lithium ion battery comprising a polymer electrolyte.

### CITATION LIST

### Patent Literature

[PTL 1] Japanese Unexamined Patent Application Publication No. 2003-217594

### SUMMARY OF THE INVENTION

### Problems to be Solved by the Invention

A solid electrolyte needs to be configured from a material having highly stable reduction resistance and high ionic conductivity, but under the current circumstances, an appropriate material has not yet been obtained. Thus, a secondary battery comprising a semisolid electrolyte, which is a gelatinous semisolid with no fluidity, has also been proposed.

Nevertheless, with a conventional secondary battery, there is a problem in that the designed battery capacity cannot be obtained after going through the manufacturing process. Thus, an object of the present invention is to provide a secondary battery, a half cell and a production method of a secondary battery capable of exhibiting the designed battery capacity.

### Means to Solve the Problems

In order to achieve the foregoing object, the present invention provides a secondary battery, comprising: an electrode containing an electrode active material and a binding agent; and an electrolyte, wherein the electrolyte contains an electrolytic solution, wherein the electrode further contains the electrolytic solution, and wherein a binding agent amount on a surface of the electrode active material is smaller than an average of the binding agent amount of the electrode.

Moreover, the present invention additionally provides a half cell, comprising: an electrode containing one of either a positive electrode active material or a negative electrode active material, and a binding agent; and an electrolyte, wherein the electrolyte contains an electrolytic solution, wherein the electrode further contains the electrolytic solution, and wherein a binding agent amount on a surface of one of either the positive electrode active material or the negative electrode active material is smaller than an average of the binding agent amount of the electrode.

Moreover, the present invention further provides a method of producing a secondary battery, comprising: a step of applying a slurry containing an electrode active material and a binding agent to a collector and drying the slurry, and subsequently pressing the slurry to prepare an electrode; a step of creating an electrolyte containing an electrolytic solution; and a step of laminating the electrode and the electrolyte and housing an obtained laminate in an exterior body, wherein the drying process includes a step of controlling conditions for the drying process so that a binding agent amount on a surface of the electrode active material becomes smaller than an average of the binding agent amount of the electrode.

### Advantageous Effects of the Invention

According to the present invention, it is possible to provide a secondary battery, a half cell and a production method of a secondary battery capable of exhibiting the designed battery capacity.

### BRIEF DESCRIPTION OF DRAWINGS

FIG. 1 is a schematic diagram showing a cross section of the secondary battery according to this embodiment.

FIG. 2 is a schematic diagram showing an average composition analysis area in the cross section of the positive electrode.

FIG. 3 is a schematic diagram showing an analysis area of the active material surface composition in the cross section of the positive electrode.

FIG. 4 is a diagram showing the pore distribution measured based on the mercury press-in method.

FIG. 5 is a diagram showing a relation between the active material surface composition ratio relative to the average composition of the binder content and the discharge capacity of the secondary battery.

### DESCRIPTION OF EMBODIMENTS

An embodiment of the secondary battery according to the present invention is now explained in detail with reference to the appended drawings.

### (1) Configuration of Secondary Battery

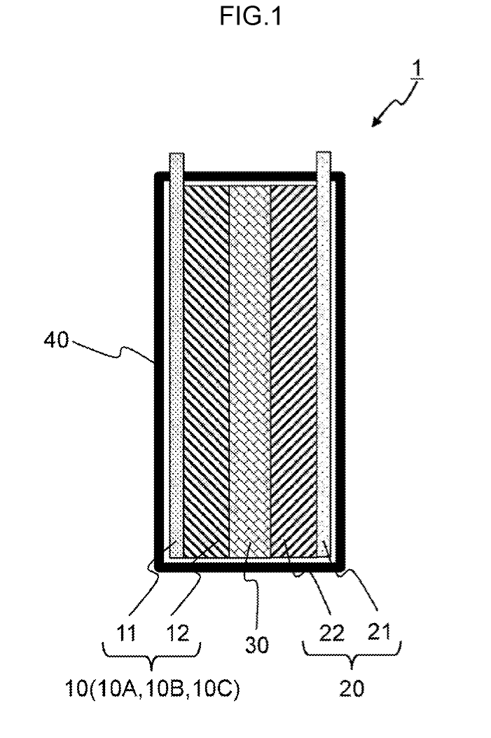

FIG. 1 is a cross section of a lithium ion secondary battery as an example of a secondary battery 1. The secondary battery 1 comprises a cell configured from a positive electrode 10, a negative electrode 20, and a semisolid electrolyte layer 30 described above, and the cell is housed in an exterior body 40.

(1-1) Configuration of Positive Electrode

The positive electrode 10 is configured from a positive electrode collector 11 and a positive electrode mixture layer 12.

Used as the positive electrode collector 11 is a conductive metal such as an aluminum foil, an aluminum perforated foil having a pore diameter of 0.1 to 10 nm, an expand metal, a foamed aluminum plate or the like. Stainless steel or titanium may also be used other than aluminum.

The thickness of the positive electrode collector 11 may be 10 nm to 1 mm, and is preferably 1 to 100 μm from the perspective of ensuring both the energy density of the secondary battery 1 and the mechanical strength of the electrode.

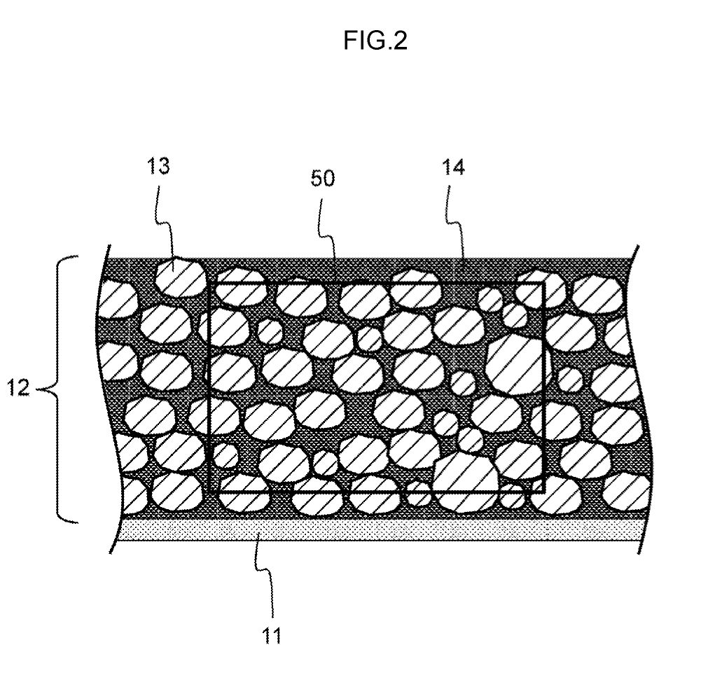

The positive electrode mixture layer 12 includes a positive electrode active material 13 (FIG. 2) which enables the occlusion and discharge of lithium ions. The positive electrode active material 13 includes, for example, one type or two or more types of lithium-containing transition metal oxide such as lithium cobalt oxide (LiCoO₂), lithium nickelate (LiNiO₂), lithium manganese oxide (LiMn₂O₄), lithium-manganese-cobalt-nickel compound oxide (LiNi_{1/3}Co_{1/3}Mn_{1/3}O₂) or the like.

The positive electrode mixture layer 12 includes a positive electrode conductive auxiliary agent 14 (FIG. 2) which is in charge of electron conductivity, an electrolytic solution which forms an ionic conduction path to the semisolid electrolyte, and a binder which binds the positive electrode active material 13, the positive electrode conductive auxiliary agent 14 and the positive electrode collector 11.

The electrolytic solution contained in the positive electrode mixture layer 12 may be the same as the electrolytic solution (described later) of the electrolyte layer 30.

The binder may be one type or two or more types of polymer such as polyvinyl fluoride, polyvinylidene fluoride (PVDF), vinylidene fluoride-hexafluoropropylene copolymer (P(VDF-HFP)), polyethylene oxide (PEO), polypropylene oxide (PPO), polytetrafluoroethylene (PTFE), polyimide, styrene-butadiene rubber or the like. Among the above, vinylidene fluoride-hexafluoropropylene copolymer (P(VDF-HFP)), in which the liquid retention properties of the electrolytic solution is high, is suitable as the binder. By increasing the liquid retention properties of the electrolytic solution, the wastage of the electrolytic solution during the pressing process can be reduced as described later.

The thickness of the positive electrode mixture layer 12 is designed according to the energy density and the rate characteristics of the secondary battery 1, and, for instance, is several μm to several hundred μm. The grain size of the positive electrode active material 13 may be equal to or less than the thickness of the positive electrode mixture layer 12, and is preferably less than half of the thickness. If there are coarse grains having a grain size that exceeds the thickness of the positive electrode mixture layer 12 in the positive electrode active material powder, for instance, the coarse grains may be eliminated via sieve classification or airflow classification.

(1-2) Configuration of Negative Electrode

The negative electrode 20 comprises a negative electrode collector 21 and a negative electrode mixture layer 22. Ends of the positive electrode collector 11 and the negative electrode collector 21 are exposed from the exterior body 40 and form an external terminal.

The negative electrode collector 21 is configured from a metal such as a copper foil, a copper perforated foil having a pore diameter of 0.1 to 10 nm, an expand metal, a foamed copper plate or the like. Stainless steel, titanium, or nickel may also be used other than copper.

The thickness of the negative electrode collector 21 is, for instance, 10 nm to 1 mm, and preferably 1 to 100 μm from the perspective of ensuring both the energy density of the secondary battery 1 and the mechanical strength of the electrode.

The negative electrode mixture layer 22 comprises a negative electrode active material which enables the occlusion and discharge of lithium ions. The negative electrode active material may be, for instance, one type or two or more types of a carbon material, an oxide, or a material which forms an alloy with lithium. This material may be, for instance, one type or two or more types of silicon, tin, germanium, lead, or aluminum.

The carbon material may be, for instance, one type or two or more types of hard carbon, soft carbon, or graphite. The oxide may be a metal oxide, for instance, one type or two or more types of silicon oxide, niobium oxide, titanium oxide, tungsten oxide, molybdenum oxide, or lithium titanate.

The negative electrode mixture layer 22 includes a negative electrode conductive auxiliary agent which is in charge of electron conductivity, an electrolytic solution which forms an ionic conduction path to the semisolid electrolyte, and a binder which binds the negative electrode active material, the negative electrode conductive auxiliary agent and the negative electrode collector 21.

The electrolytic solution of the negative electrode mixture layer 22 may be the same as the electrolytic solution (described later) of the electrolyte layer 30. The binder may also be the same as the binder of the positive electrode mixture layer 12. The thickness of the negative electrode mixture layer 22 and the grain size of the negative electrode active material may also be the same as those of the positive electrode mixture layer 12.

(1-3) Electrolyte Layer

The electrolyte layer 30 takes on the form of a gelatinous semisolid, and includes an electrolytic solution, a framework material which adsorbs the electrolytic solution, and a binder.

The electrolytic solution is a solution of lithium salt; for instance, imide system lithium salt, as the lithium source. The imide system lithium salt may be, for instance, one type or two or more types of lithium bis (fluorosulfonyl) imide (LiFSI), lithium bis (trifluoromethane sulfonyl) imide (LiTFSI), or lithium bis perfluoromethylsulfonylimide (LiBTFI).

The solvent for dissolving the lithium salt is, for instance, a low volatility material from the perspective of stability in the atmosphere and heat resistance within the battery. The low volatility material is a liquid having a vapor pressure of 150 Pa or less in an ambient temperature, and may be ambient temperature molten salt; that is, an ionic liquid, which is an aggregate of cations and anions.

The ionic liquid may be a known type so as long as it functions as an electrolyte, and, for instance, from the perspective of ionic conduction (conductivity), one type or two or more types of N, N-dimethyl-N-methyl-N-(2-methoxyethyl) ammonium bis (trifluoromethane sulfonyl) imide (DEME-TFSI), N-methyl-N-propylpiperidinium bis (trifluoromethane sulfonyl) imide (PP13-TFSI), or N-methyl-N-propylpyrrolidinium bis (fluorosulfonyl) imide (PY13-TFSI) may be used.

The electrolytic solution may contain glymes (collective designation of symmetric glycol ethers expressed as R—O (CH₂CH₂O) n-R′ (R, R′ represent saturated hydrocarbons, and n represents an integer)), and these are placed in the imide system lithium salt and configure a complex.

The glymes may be, from the perspective of ionic conduction, one type or two or more types of tetraglyme (tetraethylene dimethyl glycol, G4), triglyme (triethylene glycol dimethyl ether, G3), pentaglyme (pentaethylene glycol dimethyl ether, G5), hexaglyme (hexaethylene glycol dimethyl ether, G6).

The electrolytic solution may contain, from the perspective of ionic conduction, tetraglyme, and at least one of either lithium bis (fluorosulfonyl) imide or lithium bis (trifluoromethane sulfonyl) imide.

There is no particular limitation regarding the framework material so as long as it is a solid without any electron conductivity. The framework material is preferably fine particles (particle size of several nm to several μm) in which the surface area per unit area is large in order to increase the adsorption amount of the electrolytic solution.

The framework material may be, for example, one type or two or more types of silicon dioxide (SiO₂), aluminum oxide (Al₂O₃), titanium dioxide (TiO₂), zirconium oxide (ZrO₂), cerium oxide (CeO₂), polypropylene, or polyethylene.

The binder may be the same as the binder of the positive electrode mixture layer 12. The binder can improve the strength of the electrolyte layer 30.

### (2) Production of Secondary Battery

The electrode mixture layer (both the positive electrode mixture layer 12 and the negative electrode mixture layer 22) is prepared by going through a process of applying a slurry, a process of drying the slurry, and a process of pressing the slurry. The slurry is obtained by mixing an active material (positive electrode active material 13 or negative electrode active material), a conductive auxiliary agent (positive electrode conductive auxiliary agent 14 or negative electrode conductive auxiliary agent), a binder, and an electrolytic solution, and dispersing the mixture in a solvent. There is no particular limitation regarding the solvent so as long as it is able to dissolve the binder. The solvent is, for example, N-methyl-2-pyrrolidone (NMP).

In the coating process, the slurry is applied to a collector (positive electrode collector 11 or negative electrode collector 21). There is no particular limitation regarding the coating method, and, for instance, a doctor blade method, a dipping method, or a spray method may be used.

In the drying process, the solvent of the applied slurry is heated and eliminated. There is no particular limitation regarding the drying method, and, for instance, drying based on infrared heating or drying with hot air may be performed.

In the pressing process, for instance, a roll press machine is used to press the dried slurry to compress the volume and weight of the electrode, and thereby increase the energy capacity density of the electrode. Consequently, the electron conductivity of the electrode is increased and the charge-discharge behavior of the electrode is improved. The pressure upon pressing the electrode may be a value that is sufficient for binding the electrode mixture layer and the collector.

During the pressing process, there is a possibility that the electrolytic solution will exude from the electrode mixture layer and become attached to the press roll, whereby the electrolytic solution in the electrode mixture layer may decrease or become lost. In the foregoing case, the secondary battery 1 will not be able to exhibit the designed battery capacity. Nevertheless, as a result of intense study, the present inventors discovered that, by controlling the drying process of the slurry, it is possible to improve the distribution of the binder and the electrolytic solution in the electrode mixture layer, and inhibit the electrolytic solution in the electrode mixture layer from becoming lost during the pressing process. This discovery is now explained in further detail with reference to the ensuing Examples.

### (3) Examples

A lithium-manganese-cobalt-nickel compound oxide was used as the positive electrode active material 13, acetylene black was used as its positive electrode conductive auxiliary agent 14, and a vinylidene fluoride-hexafluoropropylene copolymer was used as its binder. An equimolar mixed liquid (solvent: LiTFSI) of tetraglyme and lithium bis (trifluoromethane sulfonyl) imide was used as the electrolytic solution of the positive electrode mixture layer 12.

The positive electrode active material 13, the positive electrode conductive auxiliary agent 14, and the binder were mixed by setting the ratio of the electrolytic solution to 74 wt %, 6 wt %, 6 wt %, and 14 wt %, respectively, and the mixture was dispersed in a solvent (N-methyl-2-pyrrolidone) to prepare a positive electrode slurry.

Next, proceeding to the coating process, the positive electrode slurry was applied, using a bar coater, to the positive electrode collector 11 made from stainless steel so that the coating weight of the solid content excluding the solvent will be 19 mg/cm².

Next, proceeding to the drying process, the drying method was changed each time to prepare positive electrodes 10A, 10B, 10C. The positive electrode 10A was obtained by drying the positive electrode slurry by exposing it to hot air of a temperature of 80° C. and an air flow of 1 m³/h for 30 minutes, the positive electrode 10B was obtained by drying the positive electrode slurry by exposing it to hot air of a temperature of 80° C. and an air flow of 5 m³/h for 20 minutes, and the positive electrode 10C was obtained by drying the positive electrode slurry by exposing it to hot air of a temperature of 100° C. and an air flow of 5 m³/h for 10 minutes. Because the time required for drying the slurry becomes shorter in proportion to the correlation of the air flow level and the temperature level, contrarily, the drying rate as the control factor of the drying process becomes greater in proportion to the correlation of the air flow level and the temperature level. With the positive electrodes 10C, 10B, 10A, the drying rate increases in that order.

Next, proceeding to the pressing process, the positive electrodes 10A, 10B, 10C were each pressed with a roll press machine at an ambient temperature. Upon performing the press, the press pressure was adjusted so that the density of the positive electrode mixture layer 12 will be 2.8 g/cc.

Graphite was used as the negative electrode active material configuring the negative electrode mixture layer 22, acetylene black was used as its conductive auxiliary agent, and a vinylidene fluoride-hexafluoropropylene copolymer was used as the binder. Furthermore, an equimolar mixed liquid (solvent: LiTFSI) of tetraglyme and lithium bis (trifluoromethane sulfonyl) imide was used as the electrolytic solution.

The negative electrode active material, the conductive auxiliary agent, and the binder were mixed by setting the ratio of the electrolytic solution to 74 wt %, 2 wt %, 10 wt %, and 14 wt %, respectively, and the mixture was dispersed in a solvent (N-methyl-2-pyrrolidone) to prepare a negative electrode slurry.

Next, in the coating process, the negative electrode slurry was applied, using a bar coater, to the negative electrode collector 21 made from stainless steel so that the coating weight of the solid content excluding the solvent will be 8.5 mg/cm².

Next, proceeding to the drying process, the negative electrode slurry was dried by exposing it to hot air of a temperature of 80° C. and an air flow of 1 m³/h to prepare a negative electrode 20. In the pressing process, the slurry was pressed with a roll press machine at an ambient temperature. The press pressure was adjusted so that the density of the negative electrode mixture layer 22 will be 1.8 g/cc.

An equimolar mixed liquid of tetraglyme and lithium bis (trifluoromethane sulfonyl) imide, SiO₂ particles having an average grain size of 7 nm, and polytetrafluoroethylene were respectively used as the electrolytic solution, the framework material, and the binder configuring the semisolid electrolyte layer 30. The ratio of the electrolytic solution, the framework material, and the binder was set to 67.5 wt %, 27.5 wt %, and 5 wt %, respectively, and, after mixing these materials, the mixture was rolled with a roll press machine to obtain a sheet-shaped electrolyte layer 30 having a thickness of 200 μm.

The positive electrode 10, the negative electrode 20, and the electrolyte layer 30 were respectively stamped out into a shape having a diameter of 16 mm, and subsequently laminated and sealed in the exterior body 40 to complete the secondary battery 1. The design capacity of the secondary battery 1 will be 4.0 mAh when calculated from the weight of the positive electrode active material 13 in the positive electrode mixture layer 12, the discharge capacity of the positive electrode active material 13, and the irreversible capacity of the positive electrode active material 13.

### (4) Evaluation of Composition of Electrode Mixture Layer

In order to observe the influence that the drying rate has on the composition of the electrode mixture layer, a scanning electron microscope (SEM) and an Energy Dispersive X-ray Spectroscopy (EDX) device were used to compare the amounts of the binder, the electrolytic solution, and the positive electrode active material 13 contained in the positive electrodes 10A, 10B, 10C. In particular, the amounts of the binder, the electrolytic solution, and the positive electrode active material 13 were analyzed in different regions of the same cross section of the positive electrode 10, and the distribution thereof was evaluated.

Components that are primarily contained in the positive electrode 10 are carbon (C), oxygen (O), fluorine (F), sulfur (S), manganese (Mn), cobalt (Co), and nickel (Ni). The fluorine content derives from the binder content and the electrolytic solution volume. The sulfur content derives from the electrolytic solution volume. Because changes in the electrolytic solution volume can be comprehended by referring to changes in the sulfur content, changes in the binder content can be deemed to be changes in the fluorine content. The contents of manganese, cobalt, and nickel derive from the positive electrode active material. The composition of the positive electrode 10 was evaluated from the contents of fluorine, sulfur, and manganese based on the relationship of the constituent elements of the positive electrode 10 and the elemental contents of the positive electrode 10.

FIG. 2 shows an enlarged view of the cross section of the positive electrode mixture layer 12. Reference numeral 50 is the region for analyzing the average content of the constituent elements of the positive electrode mixture layer 12. A scanning electron microscope was used, the magnification was set to 2000× to capture the region 50, and an Energy Dispersive X-ray Spectroscopy device was used to determine the quantity of the composition of the entire surface of the region 50. The Energy Dispersive X-ray Spectroscopy device was used to analyze the contained elements in three different visual fields, and the average value thereof was used as the average composition of the positive electrode 10.

As shown in FIG. 2, the positive electrode conductive auxiliary agent 14 is configured from primary particles having a particle size of several nm to 100 nm, and an aggregate of primary particles is formed in the positive electrode mixture layer 12. The aggregate of primary particles of the positive electrode conductive auxiliary agent 14, the positive electrode active material 13, and the positive electrode conductive auxiliary agent 14 are mutually bound by a binder.

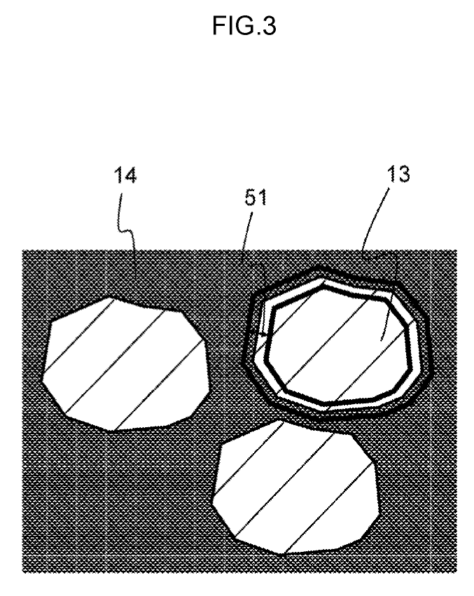

FIG. 3 is an enlarged view of the positive electrode active material 13 of the positive electrode mixture layer 12. Reference numeral 51 is the region of analyzing the composition of the active material surface. The region 51 may be a range, for instance, having a width of 2 μm from the surface of the positive electrode active material 13.

A scanning electron microscope was used, the magnification was set to 5000× to capture the region 51, and an Energy Dispersive X-ray Spectroscopy device was used to determine the quantity of the composition of the entire surface of the region 51. The Energy Dispersive X-ray Spectroscopy device was used to analyze the contained elements in three different visual fields, and the average value thereof was used as the active material surface composition of the region 51.

Table 1 shows the average composition (region 50) of the contained elements (F, S, Mn) of the positive electrode 10A, the active material surface composition (region 51), and the ratio of the active material surface composition relative to the average composition.

TABLE 1

| | (a) Average | (b) Active material | |
|---|---|---|---|
| | composition | surface composition | (b)/(a) |
| F | 7.17 wt % | 3.76 wt % | 0.52 |
| S | 0.45 wt % | 0.51 wt % | 1.1 |
| Mn | 11.02 wt % | 9.74 wt % | 0.88 |

Table 2 shows the average composition (region 50) of the contained elements (F, S, Mn) of the positive electrode 10B, the active material surface composition (region 51), and the ratio of the active material surface composition relative to the average composition.

TABLE 2

| | (a) Average | (b) Active material | |
|---|---|---|---|
| | composition | surface composition | (b)/(a) |
| F | 7.93 wt % | 4.85 wt % | 0.61 |
| S | 0.51 wt % | 0.53 wt % | 1.0 |
| Mn | 10.59 wt % | 9.97 wt % | 0.94 |

Table 3 shows the average composition (region 50) of the contained elements (F, S, Mn) of the positive electrode 10C, the active material surface composition (region 51), and the ratio of the active material surface composition relative to the average composition.

TABLE 3

| | (a) Average | (b) Active material | |
|---|---|---|---|
| | composition | surface composition | (b)/(a) |
| F | 7.53 wt % | 5.57 wt % | 0.74 |
| S | 0.50 wt % | 0.50 wt % | 0.99 |
| Mn | 10.49 wt % | 9.50 wt % | 0.91 |

In Table 1 to Table 3, (b)/(a) of S is 0.99 to 1.1, and (b)/(a) of Mn is 0.88 to 0.94. This fact demonstrates that the electrolytic solution (S) content and the active material (Mn) content are equivalent between the average composition and the active material surface composition commonly in the positive electrodes 10A to 10C. The term “equivalent” means, for example, being in a range of 0.88 to 1.1.

Meanwhile, in Table 1 to Table 3, (b)/(a) of F is 0.52 B to 0.74, and it is evident that this is considerably smaller in comparison to the ratio of S and Mn. This shows that the binder (F) content in the surface region of the active material is small. Furthermore, it can be understood that the decreased level of the binder (F) in the surface region of the active material is greater as the positive electrode has a lower drying rate; that is, in the order of the positive electrodes 10A, 10B, 10C.

Because the binder is an insulating resin, when the binder content around the active material is great, the electronic conduction required for cell reaction is obstructed, and the discharge capacity in a tolerable range from the design capacity cannot be obtained. From this perspective, the positive electrode 10A with the smallest binder content around the positive electrode active material 13 is advantageous in terms of battery properties.

The electrolytic solution is not adsorbed only on the surface of particles of the active material and the conductive auxiliary agent, the electrolytic solution is adsorbed on the surface of the binder. With regard to the electrolytic solution volume around the positive electrode active material 13, in Table 1 to Table 3, it can be understood that the value of (b) of S is 0.50 to 0.53, and is equivalent among the positive electrodes 10A to 10C. Meanwhile, while the binder content of the active material surface is different in the positive electrodes 10A to 10C as described above, there is no such difference in the electrolytic solution volume. This implies that the binder around the positive electrode active material 13 is adsorbing more electrolytic solution in the order of the positive electrodes 10A, 10B, 10C.

While the specific surface area of the active material and the conductive auxiliary agent does not change due to differences in conditions in the drying process, the precipitated shape of the binder is affected by differences in conditions in the drying process, and the specific surface area will change. More specifically, as the drying rate is slower, web-like precipitated shapes increase, and when the drying rate is increased, fine thread-like precipitated shapes increase. When the drying rate is further increased, thick thread-like precipitated shapes increase. Accordingly, as the drying rate is greater, the specific surface area of the binder becomes smaller, and the electrolytic solution volume adsorbed by the binder will decrease. In other words, in the order of the positive electrodes 10A, 10B, 10C, the specific surface area of the binder is greater, and the amount of electrolytic solution adsorbed by the same amount of binder is greater.

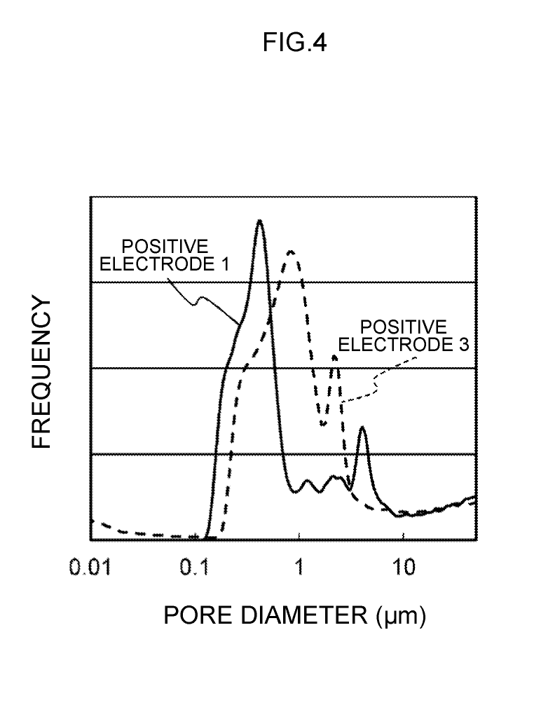

The relation of the drying rate and the composition of the electrode mixture layer was evaluated based on the pore distribution of the electrodes. FIG. 4 shows the characteristics of the pore distribution of the positive electrode 10A and the positive electrode 10C measured based on the mercury press-in method. As shown in FIG. 4, the modal diameter of the pores formed on the positive electrode 10A is 0.41 μm, and the modal diameter of the pores formed on the positive electrode 10C is 0.85 μm. It can be understood that the pores formed on the positive electrode 10A are smaller than the pores formed on the positive electrode 10C. Furthermore, because the volume of the pores for both the positive electrode 10A, 10C is 0.065 L/g, it can be understood that the positive electrode 10A is more advantageous for adsorbing the electrolytic solution in comparison to the positive electrode 10C because the specific surface area of the positive electrode mixture layer 12 is greater in comparison to that of the positive electrode 10C.

### (5) Evaluation of Discharge Behavior of Secondary Battery

The discharge capacity of the secondary battery 1 was measured by charging the secondary battery 1 in a state of a constant current of 0.2 mA until the voltage reached 4.2 V, thereafter further charging the secondary battery 1 in a state where the voltage was a constant voltage of 4.2 V to achieve a state of a full charge, and subsequently discharging the secondary battery 1 in a state of a constant current of 0.2 mA until the voltage reached 2.7 V.

Table 4 shows the discharge capacity in the secondary battery 1 which uses the positive electrodes 10A to 10C.

TABLE 4

| | Positive electrode | Positive electrode | Positive electrode |
|---|---|---|---|
| | 10A | 10B | 10C |
| Discharge | 4.0 | 3.3 | 0.4 |
| capacity (mAh) | | | |

As shown in Table 4, with the secondary battery 1 which used the positive electrode 10C having the greatest drying rate in the drying process, it was only possible to obtain a discharge capacity of only 0.4 mAh, which considerably falls below the design capacity. Meanwhile, with the secondary battery 1 which used the positive electrodes 10A, 10B having a small drying rate in the drying process, the discharge capacity was 3.3 mAh and 4.0 mAh, respectively. With the secondary battery 1 which used the positive electrode 10B, the discharge capacity was 83% of the design capacity and there is no problem in terms of practical application, but the secondary battery 1 which used the positive electrode 10A is more preferable because its discharge capacity is equivalent to the design capacity.

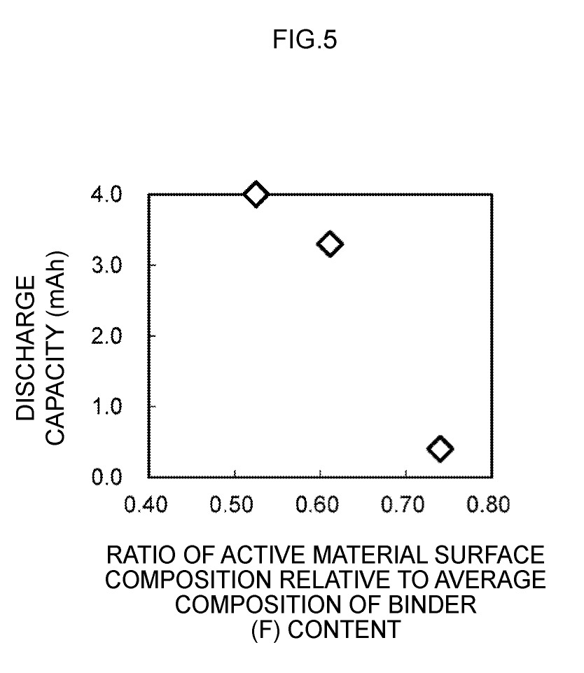

FIG. 5 shows the relationship between the active material surface composition ratio relative to the average composition of the binder (F) content and the discharge capacity of the secondary battery 1. As shown in FIG. 5, by causing the ratio of electrode active material surface relative to the average composition of the binder (F) content to be a specific value; for instance, 0.61 or less, it is possible to produce a secondary battery 1 having a discharge capacity that is 83% of the design capacity. The lower limit of the foregoing ratio may be any value in which the constituents of the electrolyte can be bound. So as long as the discharge capacity is 80% or more of the design capacity, it could be said that there are no problems in terms of practical application.

### (6) Effect of this Embodiment

As described above, with the secondary battery 1 of this embodiment, the binder content of the active material surface can be reduced without changing the electrolytic solution volume of the active material surface by controlling the conditions, such as the drying conditions, which affect the precipitated shape of the binder, and thereby controlling the binder shape of the active material surface. If the amount of the binder, which is an insulator of the active material surface, can be reduced, it will be possible to produce a secondary battery 1 having favorable battery properties. Thus, according to the secondary battery 1, the designed battery capacity can be obtained.

### (7) Other Embodiments

Note that, while the foregoing embodiment explained a case of separating the electrodes of the secondary battery 1 using an electrolyte layer 30, which is a semisolid insulator, the present invention is not limited thereto, and can be broadly applied to secondary batteries 1 in which the electrodes are separated with various other types of insulators.

Moreover, while the foregoing embodiment explained a case of forming a secondary battery 1 in which an electrolyte layer 30 is laminated between a positive electrode 10 and a negative electrode 20, the present invention is not limited thereto, the secondary battery 1 may also be formed by laminating a counter electrode on a positive electrode half cell, which is obtained by forming an electrolyte layer 30 on a positive electrode, or on a negative electrode half cell, which is obtained by forming an electrolyte layer 30 on a negative electrode. As a result of adopting a configuration of a half cell such as the foregoing positive electrode half cell or negative electrode half cell, options for the electrolytic solution can be increased, and improvement in the battery life can be expected.

Furthermore, while the foregoing embodiment explained a case of exposing a part of the positive electrode collector 11 and a part of the negative electrode collector 21 outside the exterior body 40, the present invention is not limited thereto, and the positive electrode collector 11 and the negative electrode collector 21 may be connected to an electrode terminal, without exposing a part of the positive electrode collector 11 and a part of the negative electrode collector 21 outside the exterior body 40, and the electrode terminal may be used for performing charge-discharge. Consequently, the exterior body 40 can maintain the airtightness of the positive electrode 10, the negative electrode 20 and the electrolyte layer 30 according to its shape and material.

In addition, while the foregoing embodiment explained a case where one electrolyte layer 30 was laminated, the present invention is not limited thereto, and a plurality of electrolyte layers 30 may also be laminated, or an electrode mixture layer may be formed in either side of the collector, or the laminated body may be configured so that it is wound around the axis.

In addition, while the foregoing embodiment explained a case where the electrolyte layer 30 contains a binder, the present invention is not limited thereto, and the configuration may be such that the electrolyte layer 30 does not contain a binder.

### REFERENCE SIGNS LIST

1 . . . secondary battery, 10 . . . positive electrode, 11 . . . positive electrode collector, 12 . . . positive electrode mixture layer, 13 . . . positive electrode active material, 14 . . . positive electrode conductive auxiliary agent, 20 . . . negative electrode, 21 . . . negative electrode collector, 22 . . . negative electrode mixture layer, 30 . . . electrolyte layer, 40 . . . exterior body, 50, 51 . . . region.

1. A secondary battery, comprising:
an electrode containing an electrode active material and a binding agent; and
an electrolyte,
wherein the electrolyte contains an electrolytic solution,
wherein the electrode further contains the electrolytic solution, and
wherein a binding agent amount on a surface of the electrode active material is smaller than an average of the binding agent amount of the electrode.

2. The secondary battery according to claim 1,
wherein a fluorine content contained on a surface of the electrode active material is 61% or less relative to the fluorine content contained in the electrode on average.

3. The secondary battery according to claim 1,
wherein the electrolytic solution contains tetraglyme, and at least one of either lithium bis (fluorosulfonyl) imide or lithium bis (trifluoromethane sulfonyl) imide.

4. The secondary battery according to claim 1,
wherein the binding agent contains vinylidene fluoride-hexafluoropropylene copolymer.

5. The secondary battery according to claim 1,
wherein an electrolytic solution volume on a surface of the electrode active material is equivalent to an electrolytic solution volume contained in the electrode on average.

6. A half cell, comprising:
an electrode containing one of either a positive electrode active material or a negative electrode active material, and a binding agent; and
an electrolyte,
wherein the electrolyte contains an electrolytic solution,
wherein the electrode further contains the electrolytic solution, and
wherein a binding agent amount on a surface of one of either the positive electrode active material or the negative electrode active material is smaller than an average of the binding agent amount of the electrode.

7. The half cell according to claim 6,
wherein a fluorine content contained on a surface of one of either the positive electrode active material or the negative electrode active material is 61% or less relative to the fluorine content contained in the electrode on average.

8. The half cell according to claim 6,
wherein the electrolytic solution contains tetraglyme, and at least one of either lithium bis (fluorosulfonyl) imide or lithium bis (trifluoromethane sulfonyl) imide.

9. The half cell according to claim 6,
wherein the binding agent contains vinylidene fluoride-hexafluoropropylene copolymer.

10. The half cell according to claim 6,
wherein an electrolytic solution volume on a surface of one of either the positive electrode active material or the negative electrode active material is equivalent to an electrolytic solution volume contained in the electrode on average.

11. A method of producing a secondary battery, comprising:
a step of applying a slurry containing an electrode active material and a binding agent to a collector and drying the slurry, and subsequently pressing the slurry to prepare an electrode;
a step of creating an electrolyte containing an electrolytic solution; and
a step of laminating the electrode and the electrolyte and housing an obtained laminate in an exterior body,
wherein the drying process includes a step of controlling conditions for the drying process so that a binding agent amount on a surface of the electrode active material becomes smaller than an average of the binding agent amount of the electrode.

12. The method of producing a secondary battery according to claim 11,
wherein the step of controlling conditions for the drying process causes the binding agent amount contained on a surface of the electrode active material to be 61% or less relative to the binding agent amount contained in the electrode on average.
